(19) United States
(12) Patent Application Publication
(10) Pub. No.: US 2025/0067120 A1
(43) Pub. Date: Feb. 27, 2025

(54) ROLLER BLIND AND ADJUSTING DEVICE THEREOF

(71) Applicant: CSL SUNMASTER ENTERPRISES CO., LTD., KAOHSIUNG CITY (TW)

(72) Inventor: HSIAO-HUNG TAO, KAOHSIUNG CITY (TW)

(21) Appl. No.: 18/453,685

(22) Filed: Aug. 22, 2023

(51) Int. Cl. E06B 9/60; E06B 9/42

(52) U.S. Cl. CPC E06B 9/60; E06B 9/42

(57) ABSTRACT

A roller blind and an adjusting device thereof are disclosed. The adjusting device includes an adjusting spring, an adjusting member, and a sleeve. When another end of a booster spring is positioned, a toggle portion of the adjusting member pushes the adjusting spring and the sleeve, so that an elastic force of the booster spring is changed. After the adjusting member stops rotating, the sleeve is positioned by the adjusting spring. The elastic force of the booster spring can be adjusted, without additional tools or operation space.

### FIELD OF THE INVENTION

The present invention relates to a roller blind and an adjusting device thereof, and more particularly to a roller blind having an adjustable booster spring and an adjusting device thereof.

### BACKGROUND OF THE INVENTION

A conventional roller blind that rolls up and down often uses a reel mechanism having a spring to roll a blind fabric. The spring stores the elastic potential energy when the blind fabric is pulled down. When the blind fabric is retracted, the spring releases the stored elastic potential energy to assist the reel mechanism in retracting the blind fabric, reducing the effort required by the user.

In order to adjust the retraction force of the spring according to the weight of the blind fabric, Taiwan Utility Model Publication No. M587968 discloses an elastic adjusting structure. The elastic adjusting structure comprises a shaft having a connecting portion, an operating member having a through hole, a first elastic member, an adjusting and retaining mechanism, and a tube. The adjusting and retaining mechanism includes a second elastic member, a control member, a shaft seat, a retaining seat and a C-shaped buckle. The control member includes an adjusting portion. A roller of a roller blind using the elastic adjusting structure includes an outer tube, a movable rotating shaft, a sleeve, and two brackets. By operating the adjusting portion, the control member drives the shaft to rotate and changes the first elastic potential energy of the first elastic member. The change of the second elastic potential energy of the second elastic member brings the operating member to return. The retracting force of the first elastic member can be adjusted without disassembling the roller of the roller blind, and the state after being adjusted can be kept.

However, when multiple roller blinds are installed in a row, or when the roller blinds are installed close to the wall, there may not be enough space for a tool, such as a hexagon wrench, to reach and operate the adjusting member. As a result, the entire roller blind has to be dismantled for adjusting the retracting force of the spring.

### SUMMARY OF THE INVENTION

According to one aspect of the present invention, an adjusting device for a booster spring of a roller blind is provided. The adjusting device is disposed on a roller blind body. The roller blind body includes a shaft and a booster spring adjacent to the shaft. The adjusting device comprises an adjusting spring, an adjusting member, and a sleeve. The adjusting spring is configured to tighten one end of the shaft. Two ends of the adjusting spring are formed with two protrusions that are adjacent to each other and extend away from the shaft. The adjusting member is disposed on the end of the shaft. The adjusting member has two toggle portions. The protrusions are located between the toggle portions. The sleeve is sleeved on the adjusting member. The sleeve has a block located between the protrusions. One end of the booster spring is coupled to the sleeve. When another end of the booster spring is positioned, by rotating the adjusting member, one of the toggle portions pushes one of the protrusions and the block, so that the adjusting spring stores an elastic potential energy and stops tightening the shaft, and the sleeve drives the booster spring to twist to change an elastic force of the booster spring. After the adjusting member stops rotating, the block pushes one of the protrusions away from the other protrusion, so that the adjusting spring releases the elastic potential energy to re-tighten the shaft, thereby positioning the sleeve.

According to another aspect of the present invention, a roller blind is provided. The roller blind comprises a roller blind body and the foregoing adjusting device. The roller blind body has a shaft and a booster spring adjacent to the shaft. The adjusting device is disposed on the roller blind body.

Preferably, the roller blind body includes an outer tube, a blind fabric wound around the outer tube, and a connecting member engaged with the outer tube. The other end of the booster spring is coupled to the connecting member.

Preferably, the roller blind body further includes two brackets at two ends of the outer tube.

Preferably, the adjusting member has a cylindrical portion and an annular portion adjacent to the cylindrical portion. The cylindrical portion has an opening and two wall surfaces located on two side edges of the opening. The two wall surfaces serve as the toggle portions. The adjusting spring is accommodated in the cylindrical portion. The protrusions extend into the opening.

According to above-mentioned technical features, the present invention has the following advantages:
1. By means of the adjusting spring and the adjusting member, the elastic force of the booster spring can be adjusted without additional tools or reserved tool operation space. The present invention can be widely used in various places where the roller blind is arranged densely or where the roller blind is arranged close to the wall.
2. The roller blind may be equipped with a cord, or may be a cordless roller blind or curtain to roll up and down. The adjusting device may be widely applied to different products, such as projection screens, rolling doors etc., where there is a need to adjust the internal spring force.

### BRIEF DESCRIPTION OF THE DRAWINGS

FIG. 1 is a first exploded view according to an embodiment of the present, illustrating the entire roller blind;

FIG. 2 is a second exploded view according to the embodiment of the present, illustrating the adjusting device;

FIG. 3 is a first cross-sectional view according to the embodiment of the present, illustrating the entire roller blind;

FIG. 4 is a second cross-sectional view according to the embodiment of the present, illustrating the adjusting device;

FIG. 5 is a perspective view according to the embodiment of the present, illustrating the entire roller blind;

FIG. 6 is a first cross-sectional view according to the embodiment of the present when in use, illustrating that the annular portion is rotated counterclockwise;

FIG. 7 is a second cross-sectional view according to the embodiment of the present when in use, illustrating that the booster spring is tightened;

FIG. 8 is a third cross-sectional view according to the embodiment of the present when in use, illustrating that the annular portion is rotated clockwise; and

FIG. 9 is a fourth cross-sectional view according to the embodiment of the present when in use, illustrating that the booster spring is loosened.

### DESCRIPTION OF THE PREFERRED EMBODIMENTS

Embodiments of the present invention will now be described, by way of example only, with reference to the accompanying drawings.

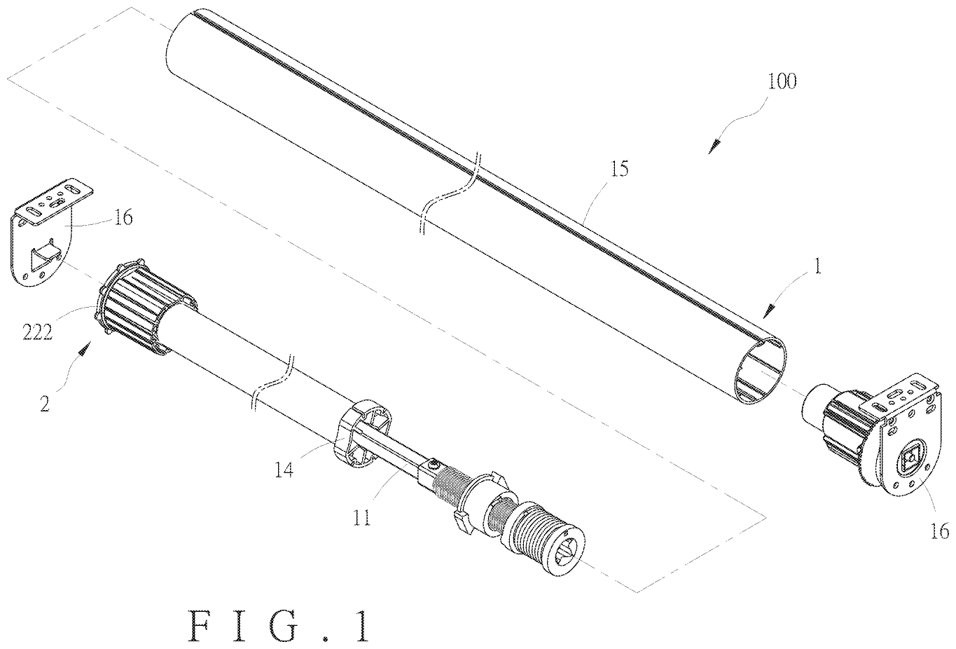

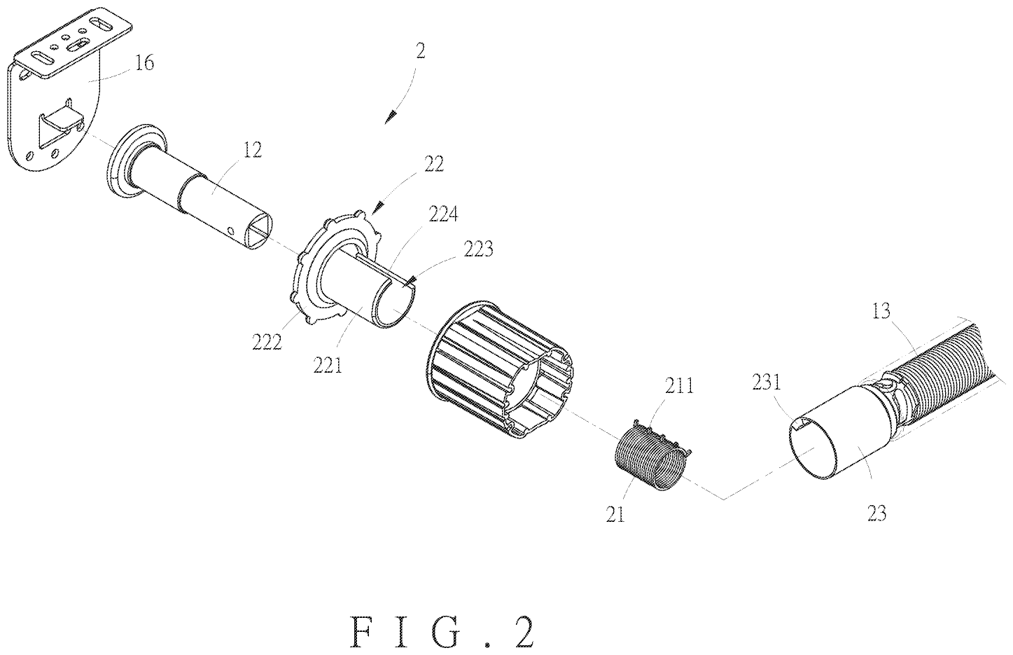

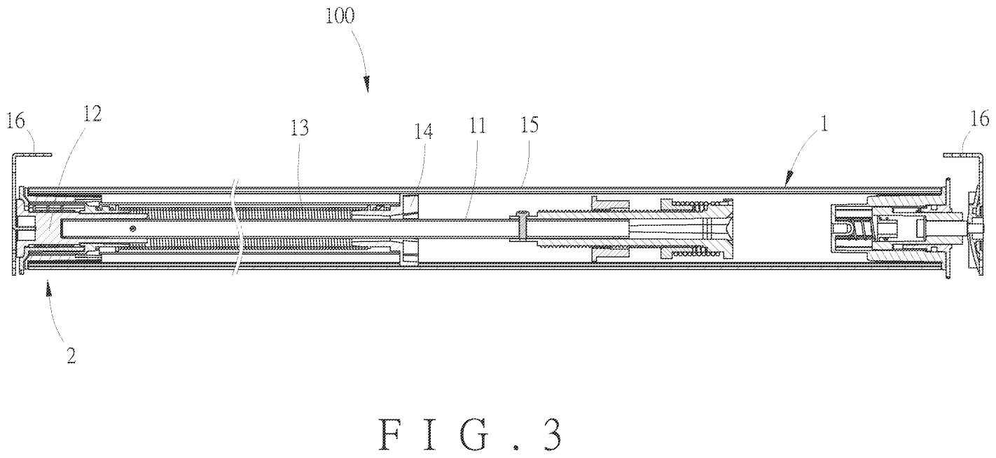

As shown in FIG. 1, FIG. 2 and FIG. 3, the present invention discloses a roller blind (hereinafter referred to as the roller blind 100) with an adjustable booster spring, comprising a roller blind body 1 and an adjusting device (hereinafter referred to as the adjusting device 2) for the booster spring of the roller blind. The adjusting device 2 is disposed on the roller blind body 1.

The roller blind body 1 includes a shaft, a booster spring 13, a connecting member 14, an outer tube 15, and two brackets 16.

The shaft is composed of a first shaft 11 and a second shaft 12 connected to the first shaft 11. The first shaft 11 is substantially a square tube. The second shaft 12 is substantially a round tube. The second shaft 12 has a square hole therein. The square hole corresponds in shape to the first shaft 11.

The booster spring 13 is sleeved on the outside of the first shaft 11.

The connecting member 14 is sleeved on the outside of the first shaft 11.

The outer tube 15 is sleeved on the outsides of the first shaft 11, the booster spring 13 and the sleeve 14. The outer tube 15 is engaged with the connecting member 14.

The two brackets 16 are disposed at two ends of the outer tube 15.

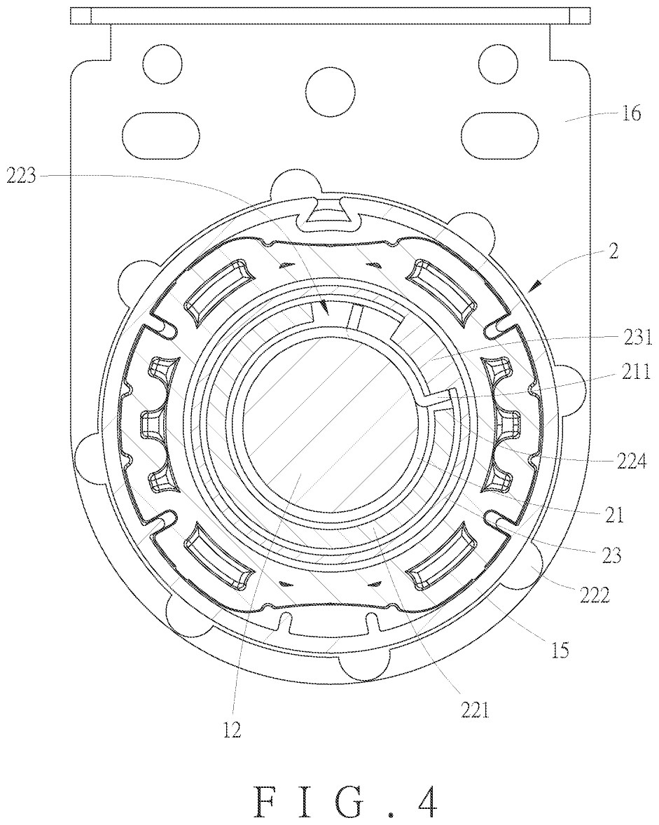

Referring to FIG. 2 through FIG. 4, the adjusting device 2 includes an adjusting spring 22, an adjusting member 22, and a sleeve 23.

The adjusting spring 21 is configured to tighten the second shaft 12. Two ends of the adjusting spring 21 are formed with two protrusions 211 that are adjacent to each other and extend away from the second shaft 12. In a preferred embodiment of the present invention, the adjusting spring 21 includes three adjacent small springs. Each spring has the two protrusions 211.

The adjusting member 22 is disposed on the second shaft 12. The adjusting member 22 has two toggle portions. The protrusions 211 are located between the toggle portions.

More specifically, the adjusting member 22 has a cylindrical portion 221 and an annular portion 222 adjacent to the cylindrical portion 221. The cylindrical portion 221 has an opening 223 and two wall surfaces 224 located on two side edges of the opening 223. The two wall surfaces 224 serve as the toggle portions. The adjusting spring 21 is accommodated in the cylindrical portion 221. The protrusions 211 extend into the opening 223.

The sleeve 23 is sleeved on the adjusting member 22. The sleeve 23 has a block 231 located between the protrusions 211. One end of the booster spring 13 is coupled to the sleeve 23, and the other end of the booster spring 13 is coupled to the connecting member 14.

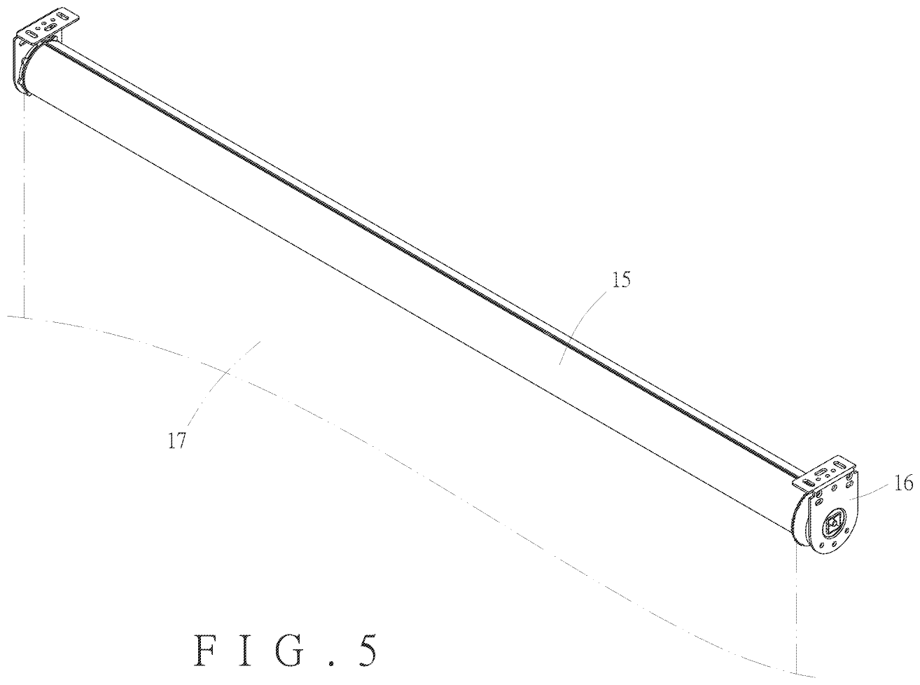

Referring to FIG. 1 and FIG. 5, the roller blind 100 further includes a blind fabric 17 wound around the outer tube 15.

In actual practice, the blind fabric 17 may be made of various materials. The roller blind 100 may be equipped with a cord, or may be a cordless roller blind or curtain to roll up and down. The roller blind 100 is retained at a desired place via the brackets 16. The adjusting device 2 may be widely applied to different products, such as projection screens, rolling doors etc., where there is a need to adjust the internal spring force.

Referring to FIG. 3 and FIG. 5, after the outer tube 15 is rotated and the blind fabric 17 is pulled down, the outer tube 15 drives the connecting member 14 to rotate so that the booster spring 13 stores its elastic potential energy. When the blind fabric 17 is retracted, the elastic potential energy released from the booster spring 13 drives the connecting member 14 and the outer tube 15 to rotate, thereby assisting in retracting the blind fabric 17.

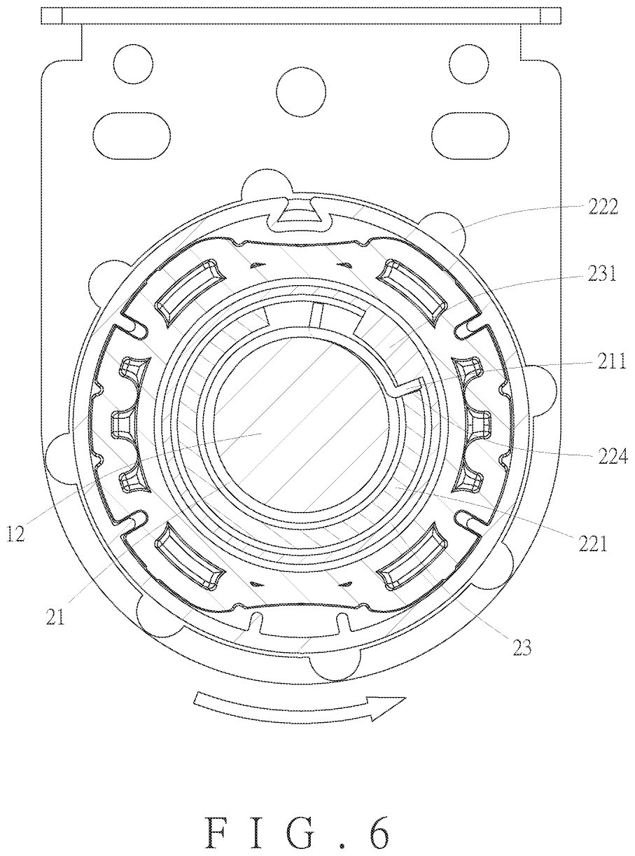

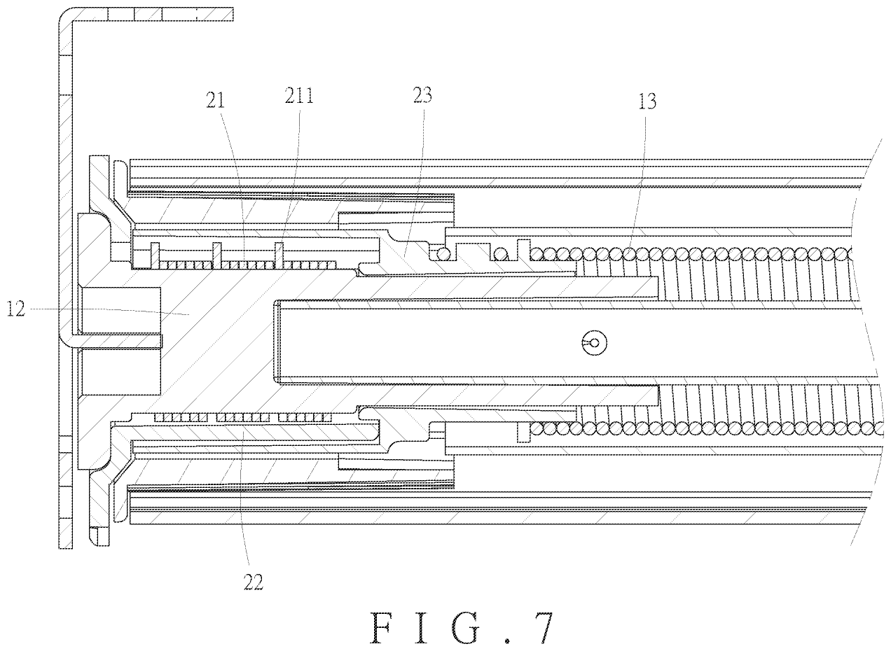

Referring to FIG. 1, FIG. 6 and FIG. 7, When the booster spring 13 is to be adjusted and tightened, the other end of the booster spring 13 is positioned by the connecting member 14 and the outer tube 15 because the outer tube 15 is not rotated.

At this time, as shown in FIG. 6, by rotating the adjusting member 22 counterclockwise, the cylindrical portion 221 is rotated counterclockwise. One of the wall surfaces 224 abuts against one of the protrusions 211, so that the adjusting spring 21 stops tightening the second shaft 12.

The adjusting member 22 is further rotated, the wall surface 224 pushes the protrusion 211 against the block 231. The adjusting member 22 drives the sleeve 23 to rotate counterclockwise. The sleeve 23 further drives the booster spring 13 to twist, so as to increase the elastic force of the booster spring 13.

After the adjusting member 22 stops rotating, the booster spring 13 drives the sleeve 23 to rotate clockwise because the booster spring 13 has a tendency to return, so that the block 231 pushes one of the protrusions 211 clockwise, and the protrusion 211 is moved away from the other protrusion 211. The adjusting spring 21 tightens the second shaft 12 again. The sleeve 23 and the booster spring 13 are positioned.

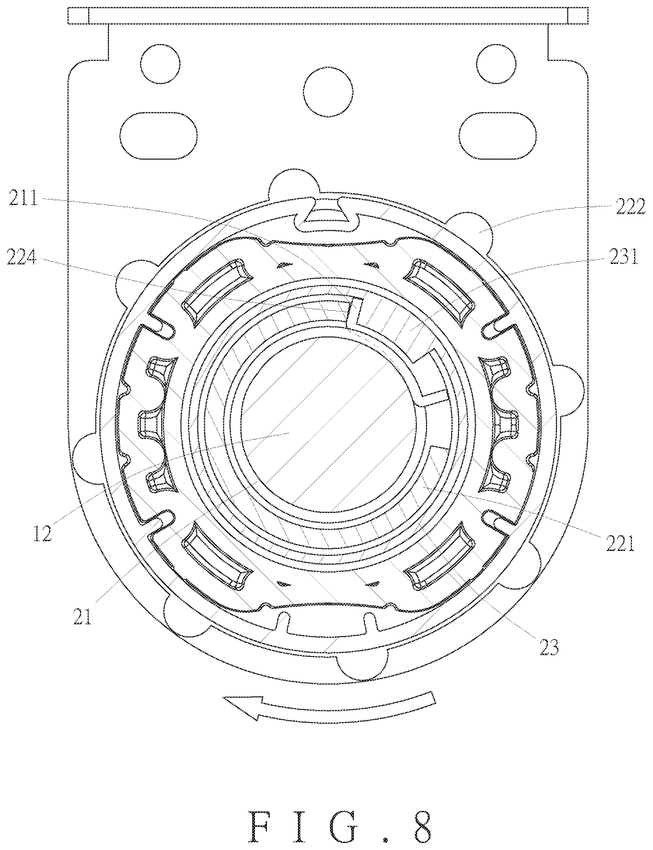

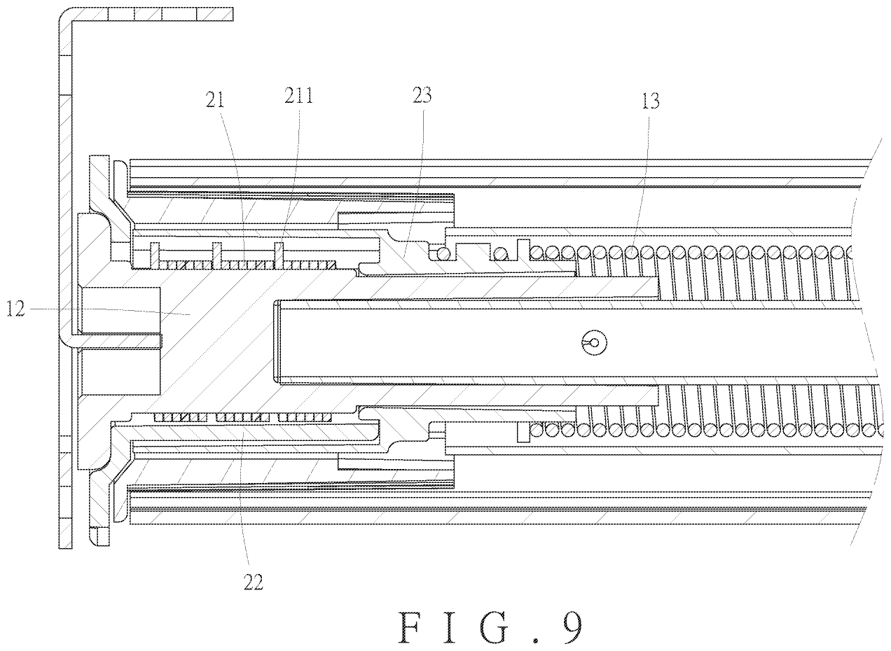

Referring to FIG. 8 and FIG. 9, when the booster spring 13 is to be loosened, the adjusting member 22 is rotated clockwise, so that the cylindrical portion 221 is rotated clockwise. The other wall surface 224 abuts against the other protrusion 211 so that the adjusting spring 21 stops tightening the second shaft 12.

The adjusting member 22 is further rotated. The other wall surface 224 pushes the other protrusion 211 against the block 231. The adjusting member 22 drives the sleeve 23 to rotate clockwise. The sleeve 23 further drives the booster spring 13 to twist, so as to reduce the elastic force of the booster spring 13.

After the adjusting member 22 stops rotating, the sleeve 23 is driven to continue to rotate clockwise because the booster spring 13 has a tendency to return, so that the block 231 pushes one of the protrusions 211 clockwise, and the protrusion 211 is moved away from the other protrusion 211. The adjusting spring 21 tightens the second shaft 12 again. The sleeve 23 and the booster spring 13 are positioned.

Referring to FIG. 2 and FIG. 3, by means of the adjusting spring 21 and the adjusting member 22, the elastic force of the booster spring 13 can be adjusted and the booster spring 13 can be positioned without additional tools or reserved tool operation space. The present invention can be widely used in various places where the roller blind 100 is arranged densely or where the roller blind 100 is arranged close to the wall.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An adjusting device for a booster spring of a roller blind, disposed on a roller blind body, the roller blind body including a shaft and a booster spring adjacent to the shaft, the adjusting device comprising:
an adjusting spring, configured to tighten one end of the shaft, two ends of the adjusting spring being formed with two protrusions that are adjacent to each other and extend away from the shaft;
an adjusting member, disposed on the end of the shaft, the adjusting member having two toggle portions, the protrusions being located between the toggle portions; and
a sleeve, sleeved on the adjusting member, the sleeve having a block located between the protrusions, one end of the booster spring being coupled to the sleeve;
wherein when another end of the booster spring is positioned, by rotating the adjusting member, one of the toggle portions pushes one of the protrusions and the block, so that the adjusting spring stores an elastic potential energy and stops tightening the shaft, and the sleeve drives the booster spring to twist to change an elastic force of the booster spring;
wherein after the adjusting member stops rotating, the block pushes one of the protrusions away from the other protrusion, so that the adjusting spring releases the elastic potential energy to re-tighten the shaft, thereby positioning the sleeve.

2. The adjusting device as claimed in claim 1, wherein the adjusting member has a cylindrical portion and an annular portion adjacent to the cylindrical portion, the cylindrical portion has an opening and two wall surfaces located on two side edges of the opening, the two wall surfaces serve as the toggle portions, the adjusting spring is accommodated in the cylindrical portion, and the protrusions extend into the opening.

3. A roller blind, comprising:
a roller blind body, having a shaft and a booster spring adjacent to the shaft; and
the adjusting device as claimed in claim 1, wherein the adjusting device is disposed on the roller blind body.

4. The roller blind as claimed in claim 3, wherein the roller blind body includes an outer tube, a blind fabric wound around the outer tube, and a connecting member engaged with the outer tube, the another end of the booster spring is coupled to the connecting member.

5. The roller blind as claimed in claim 4, wherein the roller blind body further includes two brackets at two ends of the outer tube.

6. The roller blind as claimed in claim 3, wherein the adjusting member has a cylindrical portion and an annular portion adjacent to the cylindrical portion, the cylindrical portion has an opening and two wall surfaces located on two side edges of the opening, the two wall surfaces serve as the toggle portions, the adjusting spring is accommodated in the cylindrical portion, and the protrusions extend into the opening.
